(19) United States
(12) Patent Application Publication
(10) Pub. No.: US 2007/0150557 A1
(43) Pub. Date: Jun. 28, 2007

(54) Apparatus and method for providing location-based advertisement information in a broadband wireless access communication system

(75) Inventors: Young-Ho Kim, Suwon-si (KR); Young-Soo Park, Yongin-si (KR); Jun-Young Jung, Yongin-si (KR); Joon-Young Choi, Suwon-si (KR); Geun-Ho Lee, Suwon-si (KR); Jae-Gwa Lee, Seoul (KR); Pan-Yuh Joo, Seoul (KR); Ju-Pil Kim, Suwon-si (KR); Hyun-Jeong Kang, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/643,168

(22) Filed: Dec. 21, 2006

(30) Foreign Application Priority Data
Dec. 22, 2005 (KR) 2005-0127530

(51) Int. Cl. G06F 15/16

(52) U.S. Cl. 709/219

(57) ABSTRACT

An apparatus and method are disclosed for providing location-based advertisement information in a BWA communication system, in which a shop terminal provides advertisement information to a service provider server. The service provider server uses the advertisement information as accounting information and provides path guidance information to a user terminal. A Radio Access Station (“RAS”) broadcasts or selectively sends the advertisement information to the user terminal and sends path guidance approval information received from the user terminal to the service provider server. The user terminal receives the advertisement information from the RAS, sends the path guidance approval information according to user selection, receives the path guidance information from the service provider server, and invokes a path guidance function.

### PRIORITY

This application claims priority under 35 U.S.C. § 119 to an application filed in the Korean Intellectual Property Office on Dec. 22, 2005 and assigned Serial No. 2005-127530, the contents of which are incorporated herein by reference.

### BACKGROUND OF THE INVENTION

1. Field of the Invention

The present invention relates generally to a Broadband Wireless Access (“BWA”) communication system, and, in particular, to an apparatus and method for providing a user terminal with advertisement information such as bargain sale information on a shop and providing the user terminal with information regarding path guidance to the shop based on the location of the user terminal.

2. Description of the Related Art

FIG. 1 illustrates a conventional location-based advertisement providing system. Referring to FIG. 1, advertisers, i.e. Content Providers (“CPs”) 150, send their product or service advertisements to an advertisement server 110 through their CP terminals 130 such as mobile communication terminals, Personal Computers, and the like. The advertisement messages sent from the CP terminals 130 have been assigned unique numbers according to their advertisement types.

The advertisement server 110 stores the received advertisement messages and sends them to a receiving terminal 120. The receiving terminal 120 presets the unique numbers of intended advertisement types to receive and thus selectively receives advertisement messages with the preset unique numbers from among the advertisement messages sent by the advertisement server 110.

Also, the receiving terminal 120 can receive only advertisements from CPs 150 within an area having a local unique number that corresponds to the receiving terminal 120. Specifically, a plurality of receiving terminals 120 form a common advertisement area 140 with a local unique number. CP terminals 130 in different areas send advertisements with their own local unique numbers via the advertisement server 110 and the receiving terminals 120 within the common advertisement area 140 receive only advertisement messages with the same local unique number.

Although the advertisement service is location-based, advertisement messages should be assigned advertisement type-specific numbers and the receiving terminal 120 should preset intended advertisement type-specific numbers.

In this context, the advertisement service faces many limitations. Moreover, since the advertisement service is provided over a legacy mobile communication network, only transmission of simple graphics, sounds or texts is available due to a limited data bandwidth.

### SUMMARY OF THE INVENTION

The present invention provides an apparatus and method for providing a user terminal with advertisement information such as bargain sale information on a shop and providing the user terminal with information regarding path guidance to the shop based on the location of the user terminal in a BWA communication system.

According to the present invention, there is provided a system for providing location-based advertisement information in a BWA communication system. In the location-based advertisement information providing system, a shop terminal provides advertisement information to a service provider server. The service provider server uses the advertisement information as accounting information and provides path guidance information to a user terminal. A Radio Access Station (“RAS”) receives the advertisement information from the service provider server, broadcasts or selectively sends the advertisement information to the user terminal, and sends path guidance approval information received from the user terminal to the service provider server. The user terminal receives the advertisement information from the RAS, sends the path guidance approval information according to user selection, receives the path guidance information from the service provider server, and invokes a path guidance function.

The present invention also provides a method of providing advertisement information for a location-based advertisement information providing system in a BWA communication system. In the location-based advertisement information providing method, a terminal in a shop sends advertisement information to a RAS. The RAS registers the advertisement information to a service provider server and broadcasts the advertisement information to a user terminal using an advertisement mode. The RAS receives path guidance approval information from the user terminal and sends the path guidance approval information to the service provider server. The RAS receives location-based path guidance information from the service provider server and sends the location-based path guidance information to the user terminal. The user terminal then invokes a path guidance function.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional location-based advertisement providing system;

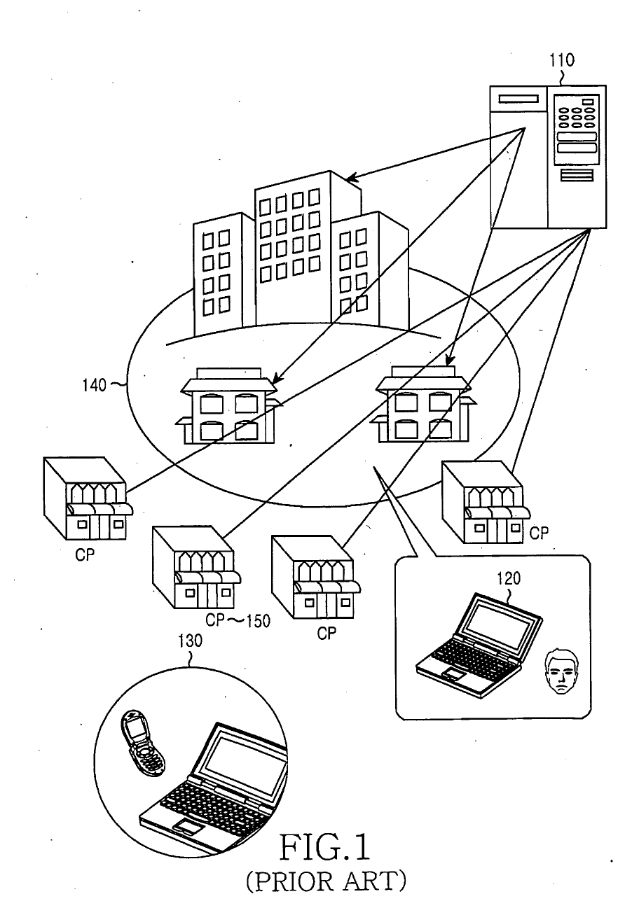

FIG. 2 illustrates the configuration of a BWA communication system according to the present invention;

FIG. 3 illustrates the configuration and operation of a location-based advertisement providing system according to the present invention;

FIG. 4 is a flowchart illustrating an operation of a service provider server according to the present invention;

FIG. 5 is a flowchart illustrating an operation of a Radio Access Station (RAS) according to the present invention;

FIG. 6 is a flowchart illustrating an operation of a user terminal according to the present invention;

FIG. 7 is a diagram illustrating a signal flow for broadcasting location-based advertisement information according to the present invention; and

FIG. 8 is a diagram illustrating a signal flow for selectively broadcasting location-based advertisement information according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

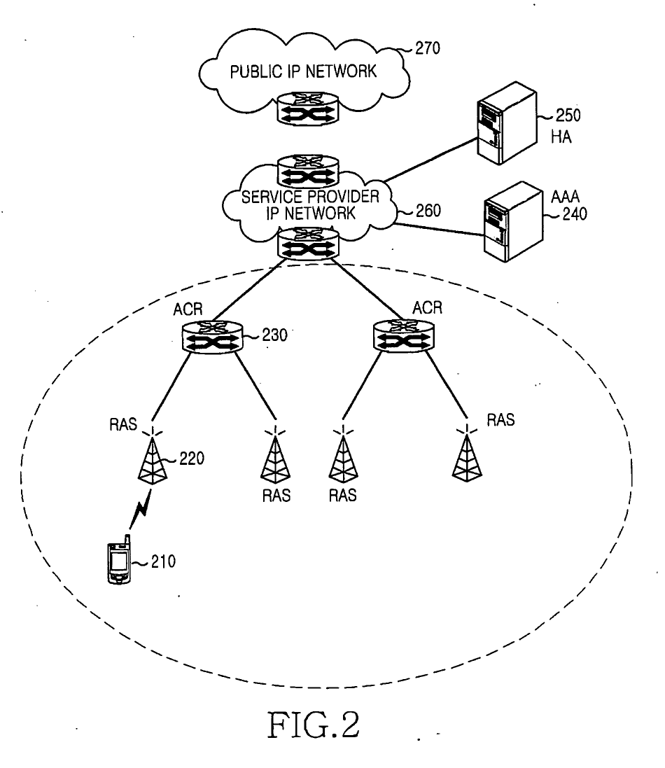

FIG. 2 illustrates the configuration of a BWA communication system according to the present invention. Referring to FIG. 2, a public Internet Protocol (“IP”) network 270 corresponds to the Internet. A service provider IP network 260 is a private network operated by a service provider, which connects a user terminal 210 to the public IP network 270 via an Access Control Router (“ACR”) 230 and a Radio Access Station (“RAS”) 220. The network entities of the service provider including a Home Agent (“HA”) 250, an Authentication, Authorization, Accounting (“AAA”) server 240, and the like reside in the service provider IP network 260.

The HA 250 is a main router operated when the user terminal 210 uses Mobile IP. The AAA server 240 is responsible for authentication, authorization, and accounting.

The BWA communication network typically operates in compliance with Institute of Electrical and Electronics Engineers (IEEE) 802.16.

The RAS 220 provides wireless communication service to the user terminal 210. The RAS 220 is also responsible for radio resource management and control, mobility support, authentication and security, Quality of Service (“QoS”) provisioning, accounting, creation and notification of statistics information, and downlink multicast.

The ACR 230 carries out the functionalities of IP routing, mobility management, authentication and security, QoS provisioning, providing accounting service to an accounting server, and mobility control, resource management, and control for RASs 220 within the ACR 230. On behalf of the RAS 220, the functionalities of authentication and security, accounting, and generation and notification of statistics information may be performed in the ACR 230 depending on system configuration.

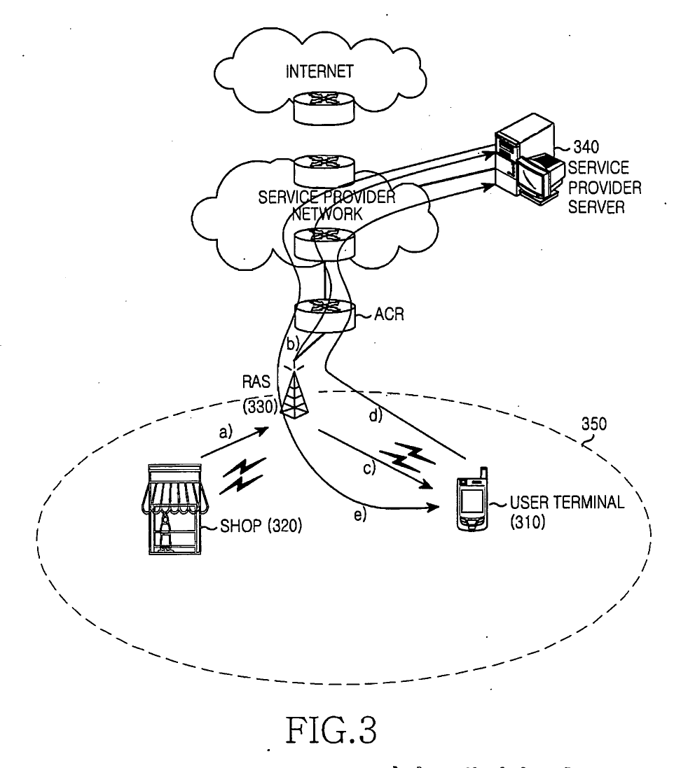

FIG. 3 illustrates the configuration and operation of a location-based advertisement providing system according to the present invention. Referring to FIG. 3, when a RAS 330 receives advertisement information regarding temporary or permanent sale pricing from a terminal of a shop 320 in step a), it sends the advertisement information to a service provider server 340 in step b). The service provider server 340 registers the advertisement information. The service provider server 340 may charge fees to the advertiser based on the registered advertisement information.

When a user terminal 310 enters the service area 350 of the RAS 330, the RAS 330 sends the advertisement information to the user terminal 310 in step c).

Advertisements may pop up in the user terminal 310 so that the user can choose whether to access the advertisements. Alternatively, advertisements are selectively sent to the user terminal 310 according to user setting, to prevent overflow of advertisements received by the user. The advertiser may offer discounts to the user depending on how many times the user accesses the advertisement.

If the user reads a received advertisement information and approves path guidance to the shop 320 that sent the advertisement information, the user terminal 310 sends approval information to the RAS 330, and the RAS 330 forwards it to the service provider server 340 in step d).

The approval information includes information about the location of the user terminal 310. If the user terminal 310 is a Global Positioning System (GPS)—enabled terminal, it sends the location information in the approval information. If the user terminal 310 is not GPS enabled, the RAS 330 includes the location information in the approval information.

Upon receipt of the approval information, the service provider server 340 sends information about path guidance to the shop 320 to the RAS 330 and the RAS 330 forwards it to the user terminal 310 in step e). The user terminal 310 then invokes a path guidance function.

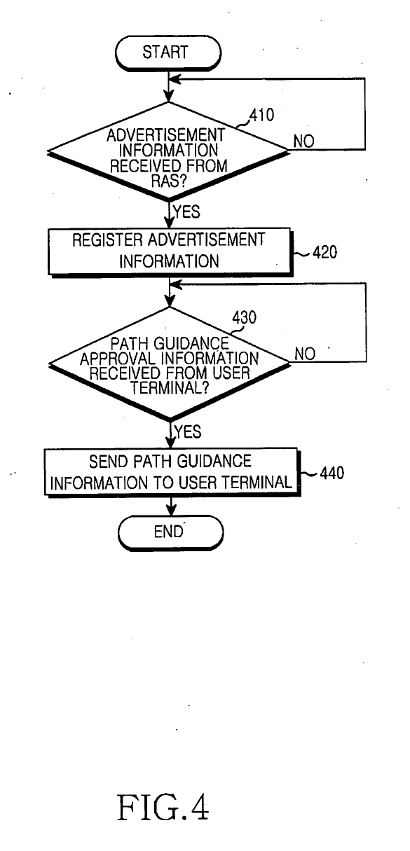

FIG. 4 is a flowchart illustrating an operation of the service provider server according to the present invention. Referring to FIGS. 3 and 4, when the service provider server 340 receives advertisement information from the RAS 330 in step 410, it registers the received advertisement information in step 420. Fees may be charged for the advertisement information.

Upon receipt of path guidance approval information from the RAS 330 in step 430, the service provider server 340 sends information about path guidance to the shop 320 based on the location of the user terminal 310 indicated by the path guidance approval information to the RAS 330 in step 440.

The registration of the advertisement information in steps 410 and 420 may not occur simultaneously with the transmission of the path guidance information in steps 430 and 440, as FIGS. 3 and 4 are not limiting, but are presented for understanding of the present invention.

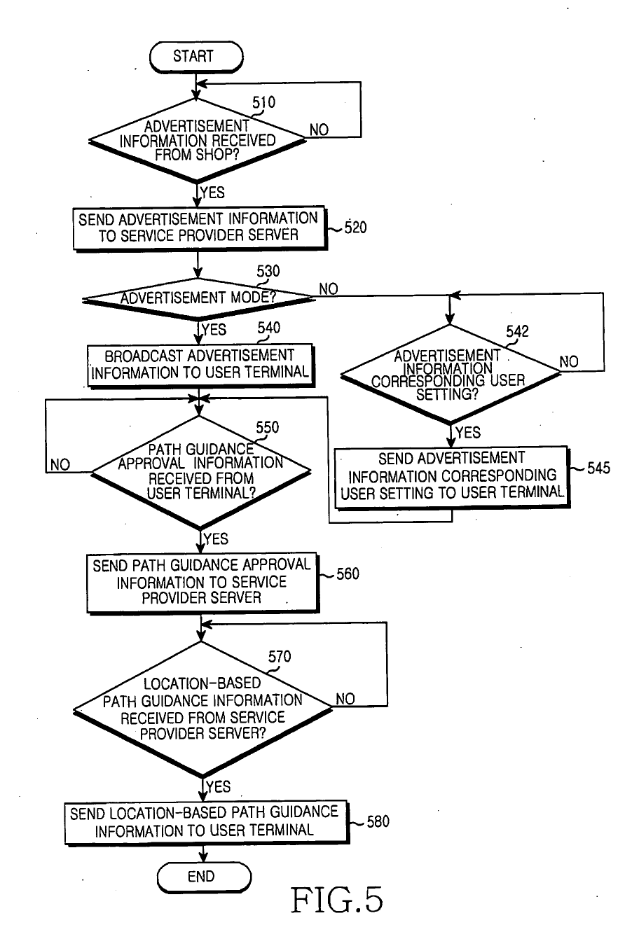

FIG. 5 is a flowchart illustrating an operation of the RAS according to the present invention. Referring to FIGS. 3 and 5, upon receipt of advertisement information from shop 320 in step 510, the RAS 330 sends the advertisement information to the service provider server 340 in step 520.

In step 530, the RAS 330 determines whether the transmission mode of the user terminal 310 within the coverage area 350 is an advertisement mode or a selective transmission mode.

When in the advertisement mode, the RAS 330 broadcasts the advertisement information to the user terminal 310 in step 540. The advertisement information contains a query as to whether path guidance to the shop 320 is to be approved. When the RAS 330 receives path guidance information from the user terminal 310 as the user approves the path guidance in step 550, it sends the path guidance information to the service provider server 340 in step 560.

If the user terminal 310 is not GPS enabled, the RAS 330 includes the location information of the user terminal 310 in the path guidance approval information.

Upon receipt of location-based path guidance information from the service provider server 340 in step 570, the RAS 330 sends the location-based path guidance information to the user terminal 310 in step 580.

On the other hand, when in the selective transmission mode, the RAS 330 determines whether there is any advertisement information corresponding to user setting in step 542 and, when in the presence of such advertisement information, sends the advertisement information to the user terminal 310 in step 545 and proceeds to step 550, as described above. After steps 550 through 580, the RAS 330 ends the algorithm of the present invention.

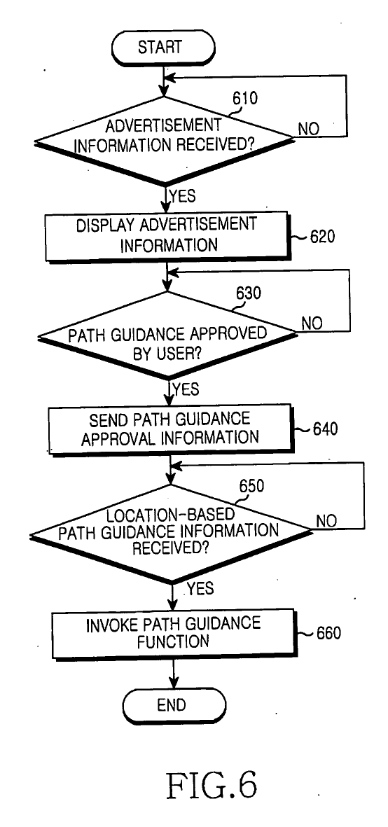

FIG. 6 is a flowchart illustrating an operation of the user terminal according to the present invention. Referring to FIGS. 3 and 6, when receiving advertisement information from the RAS 330 in step 610, the user terminal 310 displays the advertisement information on its screen in step 620.

The advertisement information may be broadcast from the RAS 330 or selectively sent from the RAS 330 according to user setting. The advertisement information contains a query as to whether path guidance to the shop 320 is to be approved. If the user approves the path guidance in step 630, the user terminal 310 sends path guidance approval information to the service provider server 340 in step 640.

If the user terminal 310 is GPS enabled, the path guidance approval information includes the location information of the user terminal 310.

Upon receipt of location-based path guidance information from the service provider server 340 in step 650, the user terminal 310 invokes the path guidance function in step 660. Then the user terminal 310 ends the algorithm of FIG. 6.

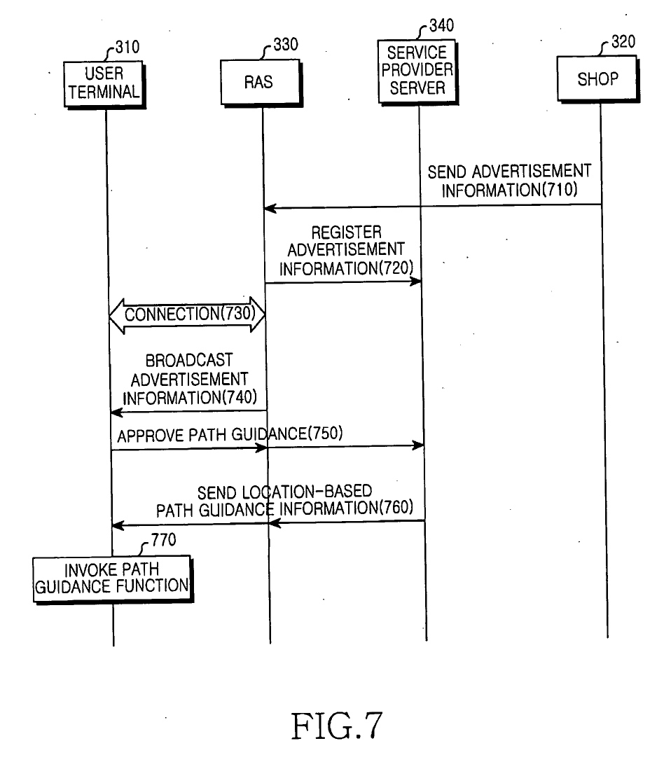

FIG. 7 is a diagram illustrating a signal flow for broadcasting location-based advertisement information according to the present invention. Referring to FIG. 7, the terminal of the shop 320 sends advertisement information regarding temporary or permanent sale pricing to the RAS 330 in step 710. In step 720, the RAS 330 registers the advertisement information to the service provider server 340. The advertiser may be charged for the registered advertisement information.

When the user terminal 310 enters the service area 350 of the RAS 330, it establishes a wireless connection for communicating with the RAS 330 in step 730. In step 740, the RAS 330 broadcasts the advertisement information.

Upon receipt of the advertisement information, the user terminal 310 sends path guidance approval information to the service provider server 340 if the user approves path guidance to the shop 320, in step 750. The path guidance approval information includes the location information of the user terminal 310.

In step 760, the service provider server 340 sends information regarding path guidance to the shop 320 based on the location information of the user terminal 310 included in the path guidance approval information by the RAS 330 or by the user terminal 310 using the GPS function. The user terminal 310 then invokes the path guidance function in step 770.

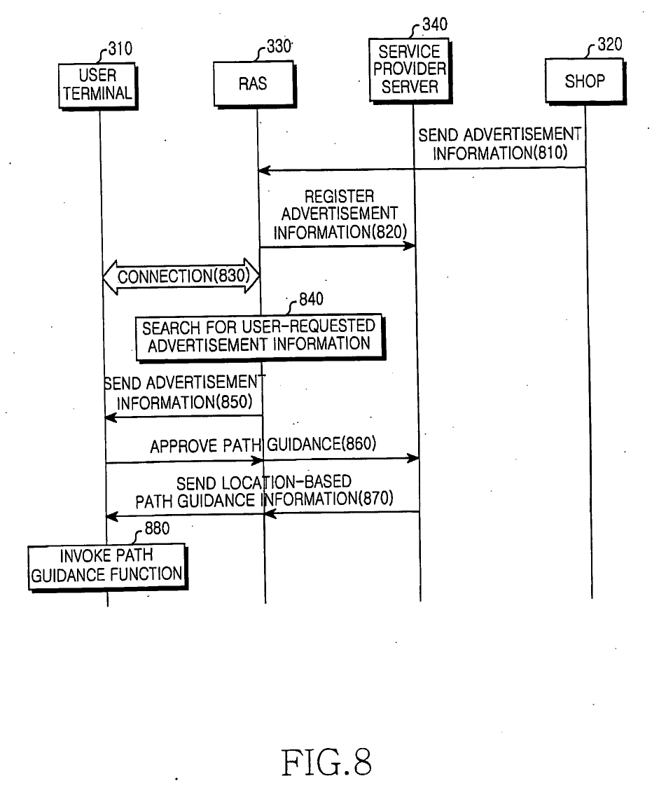

FIG. 8 is a diagram illustrating a signal flow for selectively broadcasting location-based advertisement information according to the present invention. Referring to FIG. 8, the terminal of the shop 320 sends advertisement information regarding temporary or permanent sale pricing to the RAS 330 in step 810. In step 820, the RAS 330 registers the advertisement information to the service provider server 340. The advertiser may be charged for the registered advertisement information. When the user terminal 310 enters the service area 350 of the RAS 330, it establishes a wireless connection for communicating with the RAS 330 in step 830.

In the presence of any advertisement information corresponding to user setting in step 840, the RAS 330 sends the advertisement information to the user terminal 310 in step 850.

In step 860, the user terminal 310 sends path guidance approval information to the service provider server 340 if the user approves path guidance to the shop 320 that sent the advertisement information. The path guidance approval information includes the location information of the user terminal 310.

In step 870, the service provider server 340 sends information regarding path guidance to the shop 320 based on the location information of the user terminal 310 included in the path guidance approval information by the RAS 330 or by the user terminal 310 using the GPS function. The user terminal 310 invokes the path guidance function in step 880.

As described above, the present invention advantageously providers convenient services to users by sending user-selected advertisement information or broadcasting advertisement information, and sending path guidance information. Also, since the advertisement information is sent over a BWA communication network, the transmission quality is increased, compared to transmission of advertisement information over a mobile communication network.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for providing location-based advertisement information in a Broadband Wireless Access (BWA) communication system, comprising:
a shop terminal for providing advertisement information to a service provider server;
the service provider server for using the advertisement information as accounting information and providing path guidance information to a user terminal;
a Radio Access Station (“RAS”) for receiving the advertisement information from the service provider server, broadcasting or selectively sending the advertisement information to the user terminal, and sending path guidance approval information received from the user terminal to the service provider server; and
the user terminal for receiving the advertisement information from the RAS, sending the path guidance approval information according to user selection, receiving the path guidance information from the service provider server, and invoking a path guidance function.

2. The system of claim 1, wherein, if the path guidance approval information does not include location information of the user terminal, the RAS includes the location information of the user terminal in the path guidance approval information and sends the path guidance approval information with the location information of the user terminal to the service provider server.

3. The system of claim 1, wherein, if the user terminal is Global Positioning System (“GPS”) enabled, the user terminal includes location information of the user terminal in the path guidance approval information and sends the path guidance approval information with the location information of the user terminal to the RAS.

4. The system of claim 1, wherein the service provider server generates location-based path guidance information based on the location information of the user terminal included in the path guidance approval information received from the RAS.

5. A method of providing location-based advertisement information in a service provider server for a location-based advertisement information providing system in a Broadband Wireless Access (BWA) communication system, comprising:
monitoring reception of advertisement information from a Radio Access Station (RAS);
registering the advertisement information, upon receipt of the advertisement information;
monitoring reception of path guidance approval information that includes location information of a user terminal from the RAS; and
sending, upon receipt of the path guidance approval information, location-based path guidance information to the RAS.

6. The method of claim 5, further comprising generating the location-based path guidance information according to the location information of the user terminal.

7. A method of providing location-based advertisement information in a Radio Access Station (“RAS”) for a location-based advertisement information providing system in a Broadband Wireless Access (“BWA”) communication system, comprising:
monitoring reception of advertisement information from a terminal in a shop;
sending and registering the advertisement information to a service provider server, upon receipt of the advertisement information;
broadcasting the advertisement information to a user terminal wirelessly connected to the RAS, if the user terminal is in an advertisement mode;
monitoring reception of path guidance approval information from the user terminal;
sending the path guidance approval information to the service provider server;
receiving location-based path guidance information from the service provider server; and
sending the location-based path guidance information to the user terminal.

8. The method of claim 7, further comprising:
determining whether there is any advertisement information corresponding to a user setting, if the user terminal is not in the advertisement mode;
sending, upon determining the presence of the advertisement information corresponding to user setting, the advertisement information to the user terminal; and
monitoring reception of path guidance approval information from the user terminal.

9. The method of claim 7, wherein the step of sending the path guidance approval information to the service provider server comprises:
including location information of the user terminal in the path guidance approval information; and
sending the path guidance approval information with location information of the user terminal to the service provider server, if the path guidance approval information does not include location information of the user terminal.

10. A method of receiving advertisement information in a user terminal for a location-based advertisement information providing system in a Broadband Wireless Access (“BWA”) communication system, comprising:
receiving advertisement information from a Radio Access Station (“RAS”);
displaying the advertisement information, while prompting a user to select whether to approve path guidance;
sending path guidance approval information to the RAS, if the user approves the path guidance;
monitoring reception of location-based path guidance information from the RAS; and
invoking a path guidance function, upon receipt of the location-based path guidance information.

11. The method of claim 10, wherein, if the user terminal is Global Positioning System (“GPS”) enabled, the step of sending path guidance approval information to the RAS comprises:
including location information of the user terminal in the path guidance approval information; and
sending the path guidance approval information with the location information of the user terminal to the RAS.

12. A method of providing advertisement information for a location-based advertisement information providing system in a Broadband Wireless Access (“BWA”) communication system, comprising:
sending advertisement information to a Radio Access Station (“RAS”) by a terminal in a shop;
registering the advertisement information to a service provider server by the RAS;
broadcasting the advertisement information to a user terminal using an advertisement mode by the RAS;
receiving path guidance approval information from the user terminal and sending the path guidance approval information to the service provider server by the RAS;
receiving location-based path guidance information from the service provider server and sending the location-based path guidance information to the user terminal by the RAS; and
invoking a path guidance function by the user terminal.

13. The method of claim 12, further comprising:
sending the advertisement information to a user terminal using a selective transmission mode by the RAS, after the registering; and
receiving path guidance approval information from the user terminal and sending the path guidance approval information to the service provider server by the RAS.

14. The method of claim 12, wherein the step of receiving path guidance approval information from the user terminal and sending the path guidance approval information to a service provider server by the RAS comprises:
including location information of the user terminal in the path guidance approval information; and
sending the path guidance approval information with location information of the user terminal to the service provider server by the RAS, if the path guidance approval information does not include location information of the user terminal.

15. The method of claim 12, wherein, if the user terminal is Global Positioning System (“GPS”) enabled, the step of receiving path guidance approval information from the user terminal and sending the path guidance approval information to a service provider server by the RAS comprises:
receiving path guidance approval information including location information of the user terminal from the user terminal; and
sending the path guidance approval information with the location information of the user terminal to the service provider server by the RAS.

16. A service provider server for a location-based advertisement information providing system in a Broadband Wireless Access (“BWA”) communication system, the service provider server adapted to perform operations comprising:
receiving advertisement information from a terminal in a shop and storing the advertisement information; and
sending location-based path guidance information to a Radio Access Station (“RAS”), upon receipt of path guidance approval information including location information of a user terminal from the RAS.

17. The service provider server of claim 16, wherein the operations performed by the service provider server further comprise generating the location-based path guidance information according to the location information of the user terminal.

18. A Radio Access Station (“RAS”) for a location-based advertisement information providing system in a Broadband Wireless Access (“BWA”) communication system, the RAS adapted to perform operations comprising:
receiving advertisement information from a terminal in a shop;
sending and registering the advertisement information to a service provider server;
broadcasting the advertisement information to a user terminal wirelessly connected to the RAS, if the user terminal is in an advertisement mode;
sending, upon receipt of path guidance approval information from the user terminal, path guidance approval information to the service provider server;
receiving location-based path guidance information from the service provider server; and
sending the location-based path guidance information to the user terminal.

19. The RAS of claim 18, wherein the operations performed by the RAS further comprises:
determining whether there is any advertisement information corresponding to a user setting, if the user terminal is not in the advertisement mode;
sending, upon determining the presence of the advertisement information corresponding to user setting, the advertisement information to the user terminal;
receiving the location-based path guidance information from the service provider server; and
sending the location-based path guidance information to the user terminal.

20. The RAS of claim 18, wherein sending the path guidance approval information to the service provider server comprises:
including location information of the user terminal in the path guidance approval information; and
sending the path guidance approval information with location information of the user terminal to the service provider server, if the path guidance approval information does not include the location information of the user terminal.

21. A user terminal for a location-based advertisement information providing system in a Broadband Wireless Access (“BWA”) communication system, the user terminal adapted to perform operations comprising:
receiving advertisement information from a Radio Access Station (“RAS”);
displaying the advertisement information;
sending path guidance approval information to the RAS, if a user approves path guidance; and
invoking a path guidance function, upon receipt of location-based path guidance information from the RAS.

22. The user terminal of claim 21, wherein, if the user terminal is Global Positioning System (“GPS”) enabled, the operation of sending path guidance approval information to the RAS comprises:
including location information of the user terminal in the path guidance approval information; and
sending the path guidance approval information with the location information of the user terminal to the RAS.
